(19) United States
(12) Patent Application Publication
(10) Pub. No.: US 2013/0129094 A1
(43) Pub. Date: May 23, 2013

(54) ELECTRONIC EQUIPMENT, METHOD OF CONTROLLING ELECTRONIC EQUIPMENT AND CONTROL PROGRAM FOR ELECTRONIC EQUIPMENT

(71) Applicant: Kaoru Nishiyama, Akishima-shi (JP)

(72) Inventor: Kaoru Nishiyama, Akishima-shi (JP)

(21) Appl. No.: 13/569,972

(22) Filed: Aug. 8, 2012

(30) Foreign Application Priority Data
Nov. 17, 2011 (JP) 2011-252010

(51) Int. Cl. H04L 9/00

(52) U.S. Cl. 380/277

(57) ABSTRACT

According to one embodiment, an electronic equipment includes: an instruction receiving module configured to communicate with an external equipment to receive a start-up inhibit instruction, an encryption key deletion instruction outputted from the external equipment, and an internal data deletion instruction to which an execution delay time is attached; and an instruction processing module configured to inhibit start-up of the electronic equipment to perform deletion process of the encryption key stored and to perform deletion process of the stored internal data when the start-up inhibit instruction, the encryption key deletion instruction, and the internal data deletion instruction to which the execution delay time is attached are received.

### CROSS REFERENCE TO RELATED APPLICATION(S)

The application is based upon and claims the benefit of priority from Japanese Patent Application No. 2011-252010 filed on Nov. 17, 2011, the entire contents of which are incorporated herein by reference.

### BACKGROUND

1. Field

Preferred embodiments of the present invention relate to an electronic equipment, a method of controlling an electronic equipment and a control program for an electronic equipment.

2. Description of the Related Art

In recent years, there are being popularized electronic equipments adapted for performing communication with an external equipment or equipments to have ability to implement command instructed from any other external equipment.

For example, in electronic equipments (external storage medium such as USB memory, etc.) having a wireless communication function, there exists a technology capable of setting a start time of command.

Moreover, in electronic equipments, there exists a technology such that when, e.g., a deletion command is received from any other external control module is received, there is started a timer in which the above-mentioned time is set, whereby this set-up time times up, data stored can be deleted.

Further, these technologies are applied, whereby a study is being made such that in the case where, e.g., an electronic equipment is lost, a command is transmitted to the electronic equipment to destroy data stored in the electronic equipment thus to improve security (concealment).

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a system diagram showing an example of a system in which an electronic equipment according to a preferred embodiment and a server are connected.

FIG. 2 is an outer appearance diagram showing the outer appearance of the electronic equipment according to the preferred embodiment.

FIG. 3 is a block diagram showing an example of the configuration of the electronic equipment according to the preferred embodiment.

FIGS. 4A and 4B are diagrams showing an example of an input screen of an electronic equipment A to instruct an electronic equipment B, which is used in the system in which the electronic equipment according to the embodiment and the server are connected.

FIG. 5 is a flowchart showing the operation in the case where the electronic equipment is found before delay time (within 24 H) in the system in which the electronic equipment according to the preferred embodiment and the server are connected.

FIG. 6 is a flowchart showing the operation in the case where the electronic equipment is not found before delay time (within 24 H) in the system in which the electronic equipment according to the preferred embodiment and the server are connected.

FIG. 7 is a flowchart for explaining the operation of the system in which the electronic equipment according to the preferred embodiment and the server are connected.

### DETAILED DESCRIPTION

According to one embodiment, an electronic equipment includes: an instruction receiving module configured to communicate with an external equipment to receive a start-up inhibit instruction, an encryption key deletion instruction outputted from the external equipment, and an internal data deletion instruction to which an execution delay time is attached; and an instruction processing module configured to inhibit start-up of the electronic equipment to perform deletion process of the encryption key stored and to perform deletion process of the stored internal data when the start-up inhibit instruction, the encryption key deletion instruction, and the internal data deletion instruction to which the execution delay time is attached are received.

A preferred embodiment will now be described with reference to the attached drawings.

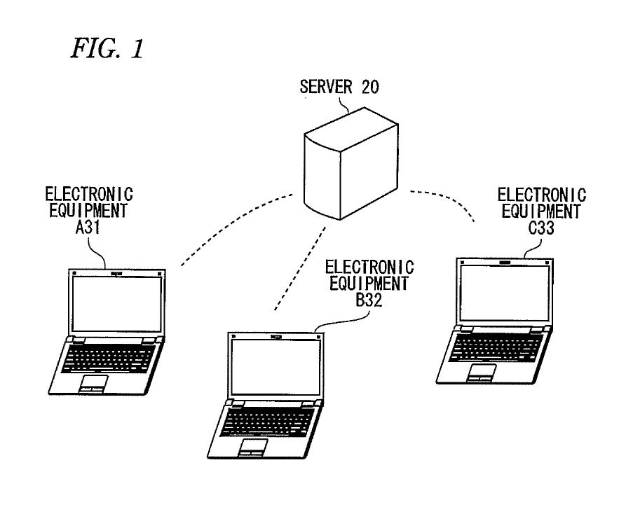

FIG. 1 is a system diagram showing an example of a system in which an electronic equipment according to a preferred embodiment and a server are connected.

In the preferred embodiment, for example, as shown in FIG. 1, a plurality of electronic equipments (PCs) of an electronic equipment A31, an electronic equipment B32 and an electronic equipment C33, etc. are connected through a server 20.

For example, the electronic equipment A31 and the electronic equipment B32 are connected through the external equipment (server 20).

Namely, the plurality of electronic equipments (PCs) of the electronic equipment A31, the electronic equipment B32 and the electronic equipment C33, etc. serve to communicate with the external equipment (server 20).

Moreover, as described later, for example, a “start-up” inhibit instruction, an “encryption key” deletion instruction and an internal data deletion instruction to which an execution “delay” time is attached are outputted from the external equipment (server 20) to the electronic equipment B32.

The “start-up” inhibit instruction, the “encryption key” deletion instruction and the internal data deletion instruction to which the execution “delay” time is attached, which are outputted from the external equipment (server 20) are received by the electronic equipment B32.

Further, in the case where the “start-up” inhibit instruction, the “encryption key” deletion instruction and the internal data deletion instruction to which the execution “delay” time is attached are received by the electronic equipment B32, the electronic equipment B32 serves to inhibit start-up of the electronic equipment B32 itself to perform deletion process of an encryption key stored in the electronic equipment B32.

At this time, the deletion process of the internal data stored in the electronic equipment B32 is delayed by the delay time.

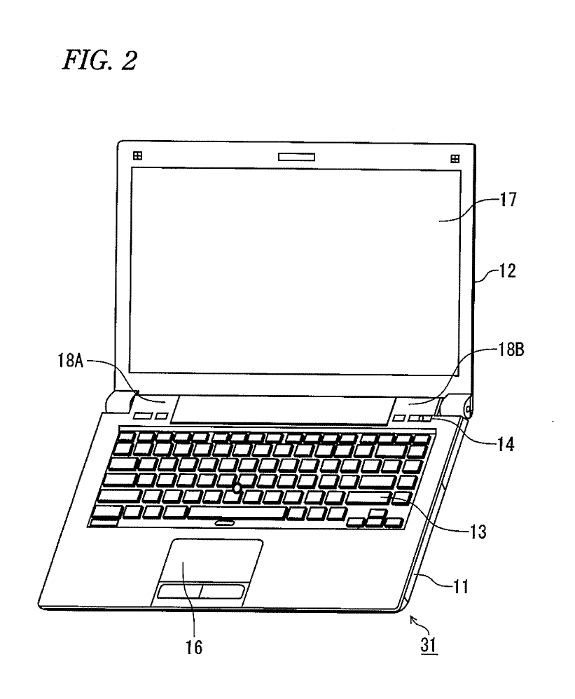

FIG. 2 is an outer appearance diagram showing the outer appearance of the electronic equipment according to the preferred embodiment.

Explanation will now be described by taking an example of the electronic equipment A31 as an example of the plurality of electronic equipments (PCs) of the electronic equipment A31, the electronic equipment B32 and the electronic equipment C33, etc.

The electronic equipment A31 is realized as, e.g., a notebook-type personal computer (which will be hereinafter simply referred to as note-PC or PC as occasion may demand) 31.

It is to be noted that this preferred embodiment is not limited to personal computers, but may be also applied to TVs (televisions), mobile telephones and/or portable electronic equipment, etc.

As shown in FIG. 2, the electronic equipment A31 comprises a computer (note-PC) body 11, and a video display module 12. Moreover, for example, a LCD (liquid crystal display) 17 is incorporated in the video display module 12.

The video display module 12 is attached at the computer (note-PC) body 11 in such a manner that it can be rotated between an opening position at which the upper part of the computer (note-PC) body 11 is exposed and a closed position at which the upper face of the computer (note-PC) body 11 is covered.

The computer (note-PC) body 11 includes a thin box-shaped casing, and includes, on the upper face thereof, a keyboard 13, a power button 14 for allowing the power supply of the electronic equipment A31 to be turned ON/OFF, a touch pad 16, and speakers 18A, 18B, etc.

Moreover, for example, on the right face of the computer (note-PC) body 11, there is provided a USB connector 19 for connecting a USB cable and/or a USB device of the USB (Universal Serial Bus) 2.0 standard.

Further, on the back face of the computer (note-PC) body 11, there is provided, for example, an external display connection terminal corresponding to the HDMI (High-Definition Multimedia Interface) standard (not shown). This external display connection terminal is used for outputting a digital video signal to an external display.

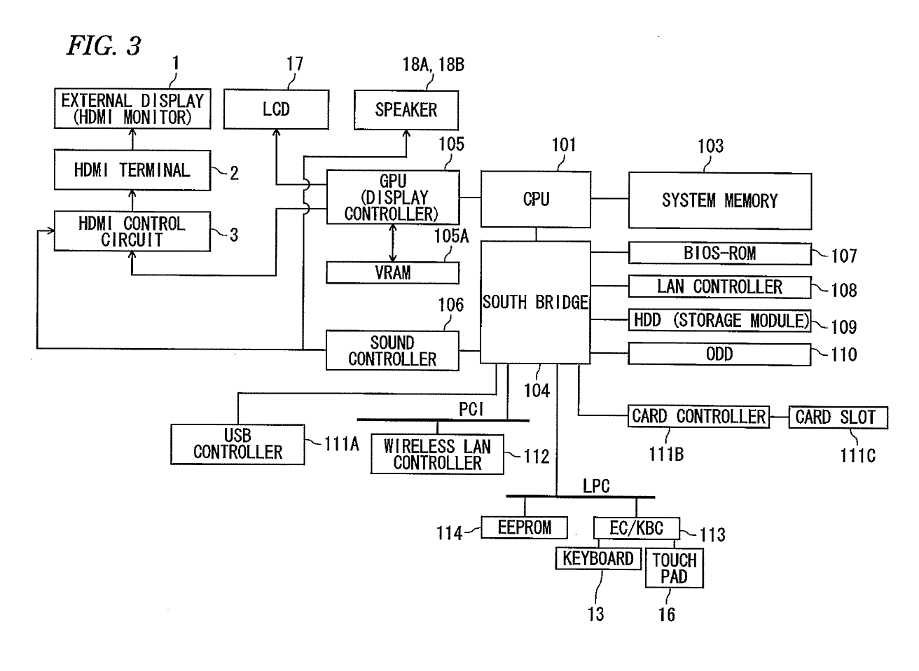

FIG. 3 is a block diagram indicating an example of the configuration of the electronic equipment according to the preferred embodiment.

The electronic equipment (client) 31 comprises, as shown in FIG. 3, a CPU (Central Processing Unit) 101, a system memory 103, a south bridge 104, a GPU (Graphics Processing Unit) 105, a VRAM (Video RAM:RandomAccess Memory) 105A, a sound controller 106, a BIOS-ROM (Basic Input/Output System-Read Only Memory) 107, a LAN (Local Area Network) controller 108, a hard disc drive (HDD (storage module)) 109, an optical disc drive (ODD) 110, a USB controller 111A, a card controller 111B, a card slot 111C, a wireless RAN controller 112, an embedded controller/keyboard controller (EC/KBC) 113, and an EEPROM (Electrically Erasable Programmable ROM) 114, etc.

The CPU 101 is a processor operative to control the operations of respective components in the electronic equipment (client) 31.

The CPU 101 serves to execute BIOS stored in the BIOS-ROM 107. The BIOS is a program for hardware control. The CPU 101 includes therewithin a memory controller for performing access control of the system memory 103. Moreover, for example, the CPU 101 also has a function to execute communication with the GPU 105 through the serial bus of the PCI EXPRESS standard, etc.

The GPU 105 is a display controller operative to control the LCD 17 used as a display monitor of the electronic equipment (client) 31.

A display signal generated by the GPU 105 is sent to the LCD 17. Moreover, the GPU 105 can send a digital video signal to the external display 1 through the HDMI control circuit 3 and the HDMI terminal 2.

The HDMI terminal 2 is the previously described external display connection terminal. The HDMI terminal 2 can send a non-compressed digital video signal and a non-compressed audio signal to the display 1 like television by way of a single cable. The HDMI control circuit 3 is an interface for sending the digital video signal to the external display 1 called HDMI monitor through the HDMI terminal 2.

The south bridge 104 serves to control respective devices on a PCI (Peripheral Component Interconnect) bus and on a LPC (Low Pin Count) bus. Moreover, the south bridge 104 includes therewithin an IDE (Integrated Drive Electronics) controller for controlling the HDD 109 and the ODD110.

Further, the south bridge has also has a function to execute communication with the sound controller 106.

The sound controller 106 is a sound source device, and serves to output audio data subject to reproduction to the speakers 18A, 18B and/or the HDMI control circuit 3. The LAN controller 108 is, e.g., a wire communication device operative to execute wire communication of the IEEE 802.3 standard. On the other hand, the wireless LAN controller 112 is a wireless communication device operative to execute, e.g., wireless communication of the IEEE 802.11g. The USB controller 111A serves to execute communication with an external equipment corresponding to the USB 2.0 standard.

For example, the USB controller 111A is used for receiving image data files stored in a digital camera. Moreover, the card controller 1113 serves to execute data write and read operations with respect to a memory card like SD card, which is inserted into a card slot provided at the computer (note-PC) body 11.

The EC/KBC 113 is an one chip microcomputer in which an embedded controller for power management and a keyboard controller for controlling the touch pad 16 are integrated. The EC/KBC 113 has a function to, allow the power supply of the electronic equipment (client) 31 to be turned ON/OFF in accordance with the operation of the power button by user.

The display control in this preferred embodiment is performed by, e.g., allowing the CPU 101 to execute programs in or on the system memory 103 and/or the HDD 109, etc.

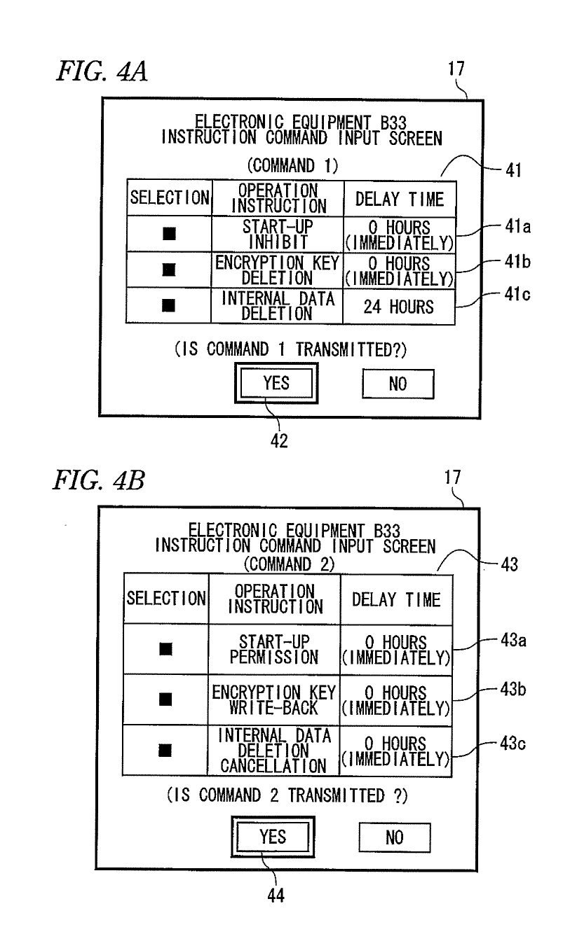

FIGS. 4A and 4B are diagrams showing an example of the input screen of the electronic equipment A to instruct the electronic equipment B used in the system in which the electronic equipment according to the preferred embodiment and the server are connected.

As described above, the electronic equipment A31 and the electronic equipment B32 are connected through the server 20, and can be respectively communicated with each other.

In this example, command to instruct the electronic equipment B32 to perform the operation is inputted to the electronic equipment A31, and is transmitted through the server 20.

FIG. 4A is an input example of the command 1 (41) transmitted to the electronic equipment B32, e.g., in order to maintain the security of internal data, etc. of lost electronic equipment B32.

In this example, the command 1 (41) is, e.g., is “start-up” inhibit instruction 41a, “encryption key” deletion instruction 41b, and internal data deletion instruction 41c.

Moreover, in this example, 0 hours (immediately) is attached to delay time of “start-up” inhibit instruction 41a, and 0 hours (immediately) is attached to “encryption key” deletion instruction 41b. However, the internal data deletion instruction 41 is adapted so that substantial execution “delay” time (e.g., 24 hours (24 H)) is attached thereto.

In this example, when these commands (“start-up” inhibit instruction 41a, “encryption key” deletion instruction 41b and internal data deletion instruction 41c) are all selected so that “Yes” 42 is indicated with respect to the inquiry of “command 1 is transmitted ?”, the command 1 (41) is transmitted to the server 20. The server 20 is operative so that when this command (41) is received, this command 1 (41) thus received is transmitted to the electronic equipment B32.

As described above, the electronic equipment B32 serves to communicate with the external equipment (server 20) to receive the “start-up” inhibit instruction, the “encryption key” deletion instruction, and the internal data deletion instruction to which the execution delay is attached, which are outputted from the external equipment (the server 20) to execute these instructions thus received.

Thus, for example, in the case where any electronic equipment is lost, the command is transmitted to the electronic equipment to destroy data stored therein to have ability to improve the security (concealment).

FIG. 4A shows, e.g., an input example of command 2 (43) to transmit, to the electronic equipment B32, a command to substantially cancel the transmitted command 1 (41) in the case where e.g. the lost electronic equipment is found,

In this example, the command 2 (43) is, e.g., “start-up” permission instruction 43a, “encryption key” write-back instruction 43b, and internal data deletion cancellation instruction 43c.

Moreover, in this example, 0 hours (immediately) is attached to the delay time of the “start-up” permission instruction 43a, and 0 hours (immediately) is attached to the delay time of the “encryption key” deletion write-back instruction 43b. Moreover, 0 hours (immediately) is attached to the delay time of the internal data deletion cancellation instruction 43c.

In this example, when these commands (“start-up” permission instruction 43a, “encryption key” write-back instruction 43b and internal data deletion cancellation instruction 43c) are all selected so that “Yes” 44 is indicated with respect to the inquiry of “command 2 is transmitted ?”, the command 2 (43) is transmitted to the server 20. When the server 20 receives this command 2 (43), it transmits the command 2 (43) thus received to the electronic equipment B32.

As described above, the electronic equipment B32 serves to communicate with the external equipment (server 20) to receive the start-up inhibit instruction to which the execution delay of 0 time (immediately) is attached, the encryption key deletion instruction and the internal data deletion instruction to execute these instructions.

Thus, it becomes possible to comply with flexibility (the degree of freedom of operation) such that, e.g., in the case where the lost electronic equipment is found, data destruction is desired to be immediately stopped thus to have ability to improve the degree of freedom of operation of the data process in the electronic equipment.

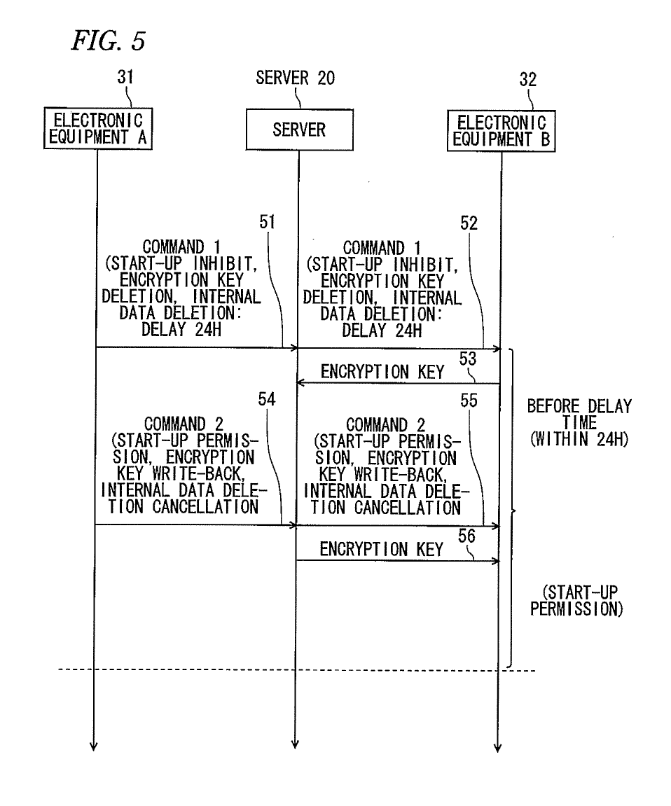

FIG. 5 is a flowchart showing the operation in the case where any electronic equipment is discovered before the delay time (within 24 H) in the system where the electronic equipment according to the embodiment and the server are connected.

In this example, for example, as described above, there is the case where the electronic equipment B32 is lost, and the electronic equipment thus lost is discovered before the delay time (within 24 H).

For example, user operates the electronic equipment A31 to perform input shown in the above-mentioned FIG. 4A to instruct transmission of the command 1 (41).

Thus, the command 1 is transmitted (51) from the electronic equipment A31 to the server 20 to which communication network is connected. As described above, the command 1 is delay time of 0 time of start-up inhibit and encryption key deletion of the electronic equipment itself. In this example, 24 hours (24 H) are attached to the delay time of the internal data deletion.

The server 20 receives this command 1 to transmit the command 1 to the electronic equipment B32 to which the communication network is connected (52).

The electronic equipment B32 receives the command 1 to execute the command 1 thus received.

Namely, start-up of the electronic equipment B32 itself is inhibited in the delay time of 0 time. Moreover, encryption key deletion is implemented in the delay time of 0 time. It is to be noted that 24 hours (24 H) are attached to the delay time of the internal data deletion as described above, whereby the internal data deletion processing is executed with a predetermined delay time (24 hours) being delayed.

It is to be noted that this delay time is, e.g., time-counted at a time-counting module constituted by the electronic equipment B32.

Moreover, in this embodiment, the encryption key stored on the HDD 109, etc. of the electronic equipment B32 is outputted to the external equipment (server 20) in accordance with the deletion process of the encryption key.

The external equipment (server 20) receives the encryption key outputted from the electronic equipment B32 to store the encryption key thus received into the storage module therewithin (not shown).

Moreover, in this example, for example, the electronic equipment B32 is discovered before the delay time (within 24 H).

In this example, for example, user operates the electronic equipment A31 to perform input shown in the above-mentioned FIG. 4B to instruct transmission of the command 2 (43).

Thus, the command 2 is transmitted from the electronic equipment A31 to the server 20 to which the communication network is connected (54). As described above, the command 2 start-up permission of the electronic equipment itself, encryption key write-back, and internal data deletion cancellation. 0 hours (0 H) are attached to these delay times.

The server 20 receives this command 2 to transmit the command 2 thus received to the electronic equipment B32 to which the communication network is connected (55).

The electronic equipment B32 receives the command 2 to execute the command 2 thus received.

Namely, start-up of the electronic equipment 32 itself is permitted. Moreover, the encryption key is written back. Further, the deletion instruction of the internal data is cancelled. 0 hours (0 H) are attached to these delay times, and delay operation is performed particularly with a delay time being provided.

At this time, the encryption key subjected to the write-back process is stored in the server 20, and is transmitted to the electronic equipment B32 in accordance with transmission of the command 2 from the server 20 to the electronic equipment B32 (56).

Thus, the electronic equipment B32 returns to the start-up enable state.

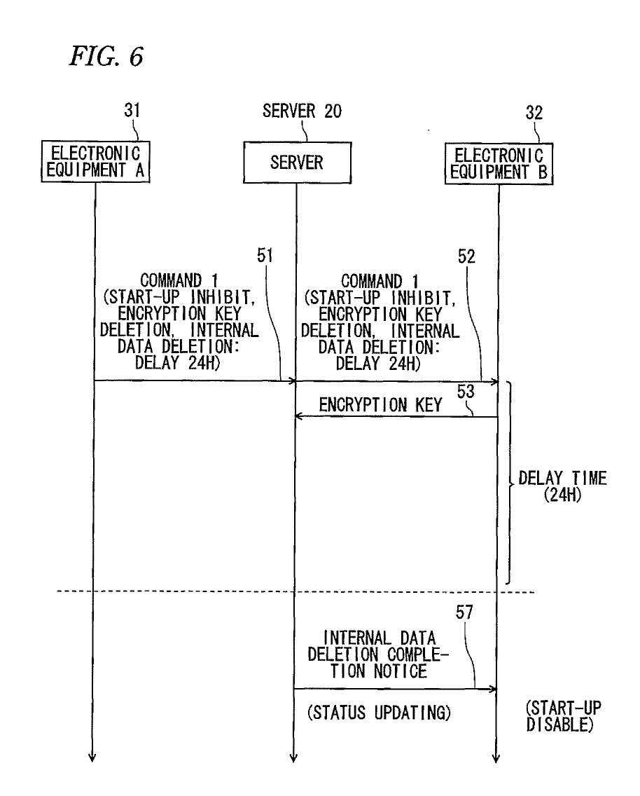

FIG. 6 shows a flowchart showing the operation in the case where any electronic equipment is not found before the delay time (within 24 H) in the system where the electronic equipment according to the preferred to the embodiment and the server are connected.

In this example, reference is made to, e.g., the case where the electronic equipment is lost as described above so that the lost electronic equipment is not found before the delay time within the 24 H.

For example, in the case where the electronic equipment 32 is lost, user operates the electronic equipment B31 to perform an input operation shown in FIG. 4A in a manner as described above to instruct transmission of the command 1 (41).

Thus, the command 1 is transmitted from the electronic equipment A31 to the server 20 to which network is connected (51). Similarly to the above, the command 1 indicates start-up inhibit of the electronic equipment itself and delay time of 0 time of the encryption key deletion. In this example, 24 hours (24 H) are attached to the delay time of the internal data deletion.

The server 20 receives this command 1 so that the command 1 is transmitted to the electronic equipment B32 to which communication network is connected (52).

The electronic equipment B32 receives the command 1 to execute the command thus received.

Namely, start-up of the electronic equipment B32 itself is inhibited in the delay time 0 time. Moreover, the encryption key deletion is implemented in the delay time 0 time. In this example, as described above, 24 hours (24 H) are attached to the internal data deletion, and the internal data deletion process is executed with a predetermined delay time (24 H) being delayed.

This delay time is time-counted, e.g., by a time-counting module constituted by the electronic equipment B32.

Moreover, in this embodiment, similarly to the above, e.g., the encryption key stored in the HDD109, etc., of the electronic equipment B32 is outputted to the external equipment (server 20) in accordance with deletion process of the encryption key.

The external equipment (server 20) receives the encryption key outputted from the electronic equipment B32 to store the encryption key thus received into a storage module therewithin (not shown).

Further, in this example, reference is made to, e.g., the case where the electronic equipment B32 is not discovered before the delay time (within 24 H).

Namely, in this example, after transmission of the command 1, user does not particularly operate the electronic equipment A31.

Moreover, the electronic equipment B32 comprises the time-counting module as described above, and serves to time-count a delay time of the internal data deletion. Further, when a correspondence time reaches the delay time (is above the delay time), e.g., the internal data stored on the HDD109, etc. is deleted.

In this example, the data deletion in this instance may be performed with a higher accuracy by performing the random deletion (data overwrite operation). This random deletion (data overwrite operation) can be also applied to deletion of the encryption key.

Moreover, in this embodiment, when the internal data deletion is implemented (or when the data deletion is completed), there is outputted internal data deletion notice to the effect that the internal data deletion has been implemented, or internal data deletion completion notice to the effect that the internal data deletion has been completed is outputted from the electronic equipment B32 to the external equipment (server 20).

When the external equipment (server 20) receives these notices, it serves to update status of the electronic equipment B32 registered in the external equipment (server 20).

Thus, the start-up disable state of the electronic equipment B32 is established. Further, it becomes possible to improve the security (concealment) of the internal data in the case where the electronic equipment B32 is lost.

By employing the configuration as described above, it becomes possible to perform a start-up control of the electronic equipment from the external, encryption control of the storage module constituted by the electronic equipment, and data deletion control of the storage module constituted by the electronic equipment, etc

Further, any electronic equipment serving to exchange commands from the external equipment (server 20) or thereto serves to set a delay time of a predetermined command to thereby have ability to control execution time of irreversible instruction such as data deletion, etc. from the server side. Moreover, for example, it becomes possible to flexibly perform, e.g., use of the system such that important data is immediately deleted, and/or a time for investigation is set after the electronic equipment is lost, etc.

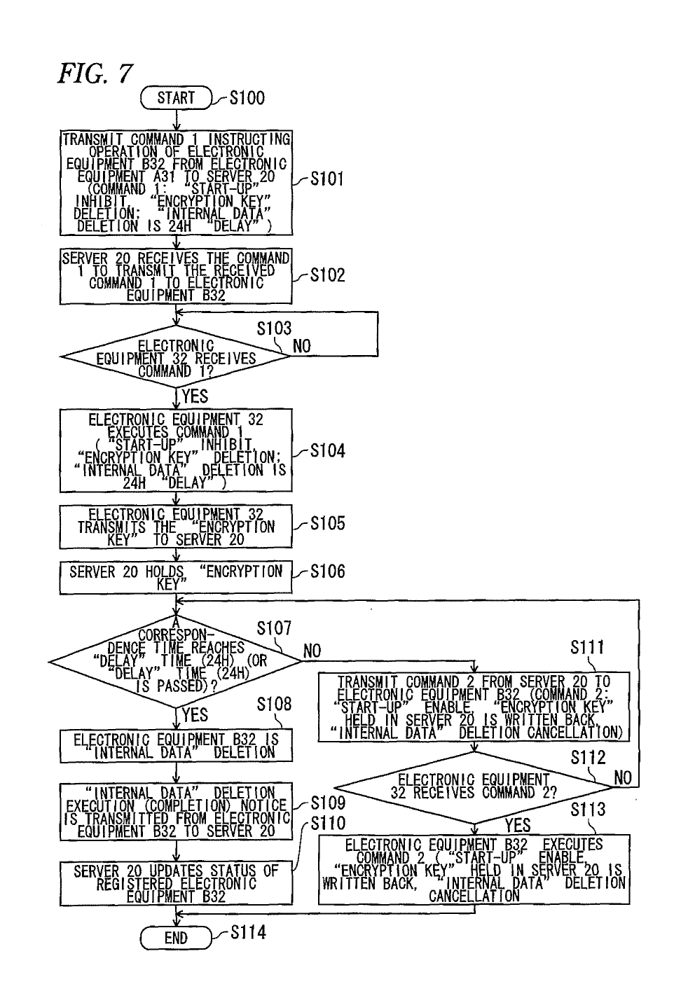

FIG. 7 is a flowchart for explaining the operation of the system in which the electronic equipment according to the preferred embodiment and the server are connected.

The step S100 is start step in this step. Subsequently, process proceeds to a step S101.

A step S101 is a step of transmitting the command 1 to instruct the operation of the electronic equipment B32 from the electronic equipment A31 to the server 20. As described above, the command 1 is, e.g., “start-up” inhibit and “encryption” deletion in the delay time of 0 time. In this example, “internal data” deletion is implemented in 24 hours. Subsequently, process proceeds to step S102.

The step S102 is a step of receiving the command 1 to transmit the command 1 thus received to the electronic equipment B32. Subsequently, process proceeds to step S103.

The step S103 is a step of detecting as to whether or not the electronic equipment 32 has received the command 1. In the case where it is detected that the electronic equipment 32 has received the command 1, process proceeds to a step S104 (Yes). In the case where it is not detected that the electronic equipment 32 has received the command 1, process in this step is repeated (No).

The step S104 is a step of allowing the electronic equipment 32 to execute the command 1. As described above, “start-up” inhibit of the electronic equipment 32 and the “encryption key” deletion are executed, and “internal data” deletion is “delayed” by 24 H and is thus executed. Subsequently, process proceeds to a step S105.

The step S105 is a step of allowing the electronic equipment B32 to transmit the “encryption key” to the server 20. Subsequently, process proceeds to a step S106.

The step S106 is a step of allowing the server 20 to hold “encryption key”. Subsequently, process proceeds to a step S107.

The step S107 is a step of detecting as to whether or not a correspondence time reaches “delay” time (24 H) attached to the internal data deletion (or that “relay” time (24 H) is passed), process proceeds to a step S108 (Yes). In the case where it is detected that a correspondence time does not reach the “delay” time (24 H) attached to the internal data deletion (or that “relay” time (24 H) is not passed), process proceeds to a step Sill (No).

A step S108 is a step of allowing electronic equipment B32 to delete “internal data”. Subsequently, process proceeds to a step S109.

The step S109 is a step of transmitting a notice to the effect that the “internal data” deletion has been executed (or is completed) from the electronic equipment B32 to the server 20.

The step S110 is a step of allowing the server 20 to update status of the registered electronic equipment B32. Subsequently, process proceeds to a step S114.

The step S111 is a step of transmitting the command 2 from the server 20 to the electronic equipment B32. As described above, the command 2 serves to write-back “encryption key” held in the server so that “start-up” of the electronic equipment B32 can be executed in the delay time of 0 time to perform deletion cancellation of the “internal data”. Subsequently, process proceeds to a step S112.

The step S112 is a step of detecting as to whether or not the electronic equipment B32 has received the command 2. In the case where the command 2 is received, process proceeds to a step S113 (Yes). In the case where the electronic equipment B32 does not receive the command 2, process returns to the step S107 to repeat the process (No).

A step S113 is a step of allowing the electronic equipment B32 to execute the command 2. Namely, the electronic equipment B32 is placed in “start-up” enable in the delay time 0 time, and the “encryption key” is written back in a manner as described above. Moreover, deletion instruction of “internal data” is cancelled. Subsequently, process proceeds to a step S114.

The step S114 is an end step, wherein process in this step completed.

Moreover, in the preferred embodiment, the electronic equipment can be constituted by, e.g., a battery driven portable terminal. In this case, it is desirable that the electronic equipment includes communication means which can be energized at all times at the time of power supply OFF, and a RTC (Real Time Crock) for measuring time.

The RTC is an only time-counting IC mounted on, e.g., a mother board. This RTC is supplied with a power supply from a battery included at the time when the power supply is turned ON so that it can be operated.

Moreover, the electronic equipment receives application in another electronic equipment or command from the server existing on the network by way of communicating means such as wireless means from a remote place to have ability to receive various kinds of commands such as permission of start-up, inhibit of the start-up, deletion of the encryption key of internal data, write-back of the encryption key of the internal data, and/or deletion of internal data, etc.

Moreover, the command is classified into reversible operation such as start-up control and/or encryption key operation of internal data, etc. and irreversible data such as deletion of internal data, etc.

Further, as described above, a delay time is specified in a command received by the electronic equipment. The electronic equipment serves to perform time-count operation from the command receiving time to execute the command thus received after the delay time thus specified is passed.

Further, in the case where loss of the electronic equipment is discovered, deletion commands of inhibit of start-up and the encryption key of the internal data are issued in the delay time of 0 time. At the same time, deletion command of the internal data is issued in the delay time of 24 time.

Further, in the case where the electronic equipment is discovered within 24 hours until the data deletion, command indicating permission of start-up and write-back command for encryption key of the internal data is issued in the delay time of 0 time to thereby have ability to return to the state before loss to continue use of the electronic equipment.

Further, in the case where the electronic equipment is not found within the delay time (24 hours) until the data deletion, the data deletion is executed so that leakage of internal secrete information can be prevented.

In the case embodiment, a delay time is specified with respect to a predetermined command. Thus, it becomes possible to flexibly use reversible instruction such as data deletion, etc.

By employing the configuration as described above, in the case where e.g., the electronic equipment is lost in this preferred embodiment, command to destroy stored data is transmitted, whereas in the case where the lost electronic equipment is discovered, it becomes to possible to immediately comply with flexibility such that data destruction is stopped (the degree of freedom of operation) to improve the degree of freedom.

It is to be noted that the procedure of the control process of the preferred embodiment can be all executed by software. For this reason, this program is installed into an ordinary computer through a computer readable storage medium in which programs for executing the procedure of the control process are stored to execute the program thus installed, thereby making it possible to realize effects/advantage similar to those of the preferred embodiment.

It should be noted that the preferred embodiments are not limited to the description thereof, and may be embodied with components being variously modified of changed within the scope which does not depart from the gist thereof at the implementation stage.

In addition, various inventions may be formed by a suitable combination of a plurality of components disclosed in the preferred embodiments.

For example, several components may be deleted from all components disclosed in the preferred embodiment. Furthermore, components ranging over different embodiments may be combined as occasion demands.

1. An electronic equipment comprising:
an instruction receiving module configured to communicate with an external equipment to receive a start-up inhibit instruction, an encryption key deletion instruction outputted from the external equipment, and an internal data deletion instruction to which an execution delay time is attached; and
an instruction processing module configured to inhibit start-up of the electronic equipment to perform a deletion process of an encryption key stored and to perform deletion process of stored internal data when the start-up inhibit instruction, the encryption key deletion instruction, and the internal data deletion instruction to which the execution delay time is attached are received.

2. An electronic equipment according to claim 1, wherein
the stored encryption key is outputted to the external equipment in accordance with deletion process of the encryption key.

3. An electronic equipment according to claim 1, comprising:
a deletion process module configured to detect as to whether or not a correspondence time reaches a delay time required for delaying deletion process of the internal data, whereby the deletion process module serves to execute deletion process of the internal data when the correspondence time reaches the delay time.

4. An electronic equipment according to claim 1, wherein
execution of the deletion process is notified to the external equipment when the deletion process of the internal data is executed.

5. An electronic equipment according to claim 3, wherein
the electronic equipment is permitted to be started by itself to perform write-back process of the encryption key, but not to perform the internal data deletion process in a case that a start-up enable instruction, an encryption key write-back instruction and a cancellation instruction of the internal data deletion are received when the correspondence time does not reach the delay time.

6. An electronic equipment according to claim 5, wherein
the encryption key subjected to the write-back process is outputted from the external equipment.

7. An external equipment for an electronic equipment comprising:
a receiver configured to receive the encryption key outputted from an electronic equipment; and
a storage configured to store the encryption key that is received, wherein
the electronic equipment comprising:
an instruction receiving module configured to communicate with the external equipment to receive a start-up inhibit instruction, an encryption key deletion instruction, and an internal data deletion instruction to which an execution delay time is attached; and
an instruction processing module configured to inhibit start-up of the electronic equipment to perform deletion process of the encryption key stored and to perform deletion process of the stored internal data when the start-up inhibit instruction, the encryption key deletion instruction, and the internal data deletion instruction to which the execution delay time is attached are received.

8. An external equipment according to claim 7 being is operative to receive signaling outputted from the electronic equipment to update status of the electronic equipment.

9. A method of controlling an electronic equipment comprising:
communicating with an external equipment to receive a start-up inhibit instruction, an encryption key deletion instruction, and an internal data deletion instruction to which an execution delay time is attached; and
inhibiting start-up of the electronic equipment to perform deletion process of the encryption key stored and to perform deletion process of the stored internal data when the start-up inhibit instruction, the encryption key deletion instruction, and the internal data deletion instruction to which the execution delay time is attached are received.

10. A control program of controlling an electronic equipment comprising:
communicating with an external equipment to receive a start-up inhibit instruction, an encryption deletion instruction, and an internal data deletion instruction to which an execution delay time is attached; and
inhibiting start-up of the electronic equipment to perform deletion process of the encryption key stored and to perform deletion process of the stored internal data when the start-up inhibit instruction, the encryption key deletion instruction, and the internal data deletion instruction to which the execution delay time is attached are received.
